(19) United States
(12) Patent Application Publication
(10) Pub. No.: US 2018/0332239 A1
(43) Pub. Date: Nov. 15, 2018

(54) BACKGROUND REPLACEMENT UTILIZING INFRARED LIGHT AND VISIBLE LIGHT

(71) Applicant: Lifetouch Inc., Eden Prairie, MN (US)

(72) Inventors: Brent Peterson, Chanhassen, MN (US); Michael Surma, Eagan, MN (US)

(21) Appl. No.: 15/591,347

(22) Filed: May 10, 2017

(51) Int. Cl. H04N 5/272; H04N 5/222; H04N 5/33; G06T 7/194

(52) U.S. Cl. CPC H04N 5/272; H04N 5/2226; G06T 2207/10024; G06T 7/194; G06T 2207/10048; H04N 5/332

(57) ABSTRACT

Systems and methods for background replacement of images captured using both infrared light and visible light are disclosed. Example methods of imaging a subject include capturing an image while illuminating a subject with a visible light assembly and illuminating a background with an infrared light assembly. Digital cameras capturing subject images during illumination include image sensor arrays having both visible light sensors and infrared light sensors.

### BACKGROUND

Professional photographic images are often obtained in an artificially lighted environment. Example types of images captured in this environment include school portraits, printed publication images, product packaging or marketing images, and athletic, church, or club portraits. It is sometimes desirable to change the background behind the subject of the image, which requires additional processing of the image after its capture. Some existing methods for background replacement, such as chroma key, accomplish this objective but the resulting images can lack the crisp precision expected from professionally-captured photographs and require that the subject avoid certain colors of clothing.

Other background replacement systems rely upon the capture of multiple images in quick succession to create a mask that identifies the placement of the subject in the image. Such techniques work well with very high speed photography methods or with relatively stationary subjects. But when the subject is moving, many camera systems cannot capture images fast enough to allow an accurate mask to be generated.

### SUMMARY

In general terms, this disclosure is directed to systems and methods for background replacement in digital photographs. The background replacement systems utilize infrared light and visible light during image capture. Various aspects are described in this disclosure, which include, but are not limited to, the following aspects.

In one aspect, a method of imaging a subject with a digital camera includes illuminating a subject with a visible light assembly and illuminating a background with an infrared light assembly. While illuminating the subject and illuminating the background, the method also includes capturing an image with the digital camera. The digital camera has an image sensor array that includes sensors configured to receive visible light and sensors configured to receive infrared light.

In another aspect, a digital photography system includes a digital camera including a sensor array, where the sensor array is configured to capture both visible light and infrared light. The system also includes a background lighting system including an infrared lighting unit, a subject lighting system including a visible lighting unit, and a controller in communication with the background lighting system and the subject lighting system. The controller includes at least one processing device and at least one non-transitory data storage device. The instructions, when executed by the at least one processing device, cause the controller to activate the background lighting system to emit infrared light, activate the subject lighting system to emit visible light, and, when both the background lighting system and the subject lighting system are activated, activate the digital camera to capture an image with the sensor array.

Another aspect is a method for replacing a digital image background, where the digital image includes a subject. The method includes receiving an infrared image file, and, using the infrared image, generating a mask. The infrared image is captured with an image sensor array including a plurality of infrared sensors and a plurality of visible light sensors.

### BRIEF DESCRIPTION OF THE DRAWINGS

FIG. 1 illustrates an example system for producing photographs of a subject.

FIG. 2 illustrates an example photography station for illuminating and capturing photographs.

FIG. 3 is a schematic block diagram of an example camera of the photography station shown in FIG. 2.

FIG. 4 is a schematic diagram of an RGB/IR image sensor array of the camera shown in FIG. 3.

FIG. 5 is a schematic block diagram of an example controller of the photography station shown in FIG. 2.

FIG. 6 is a schematic block diagram illustrating architecture of an example computing device of the photography station shown in FIG. 2.

FIG. 7 is a schematic diagram of filters used in the example photography station shown in FIG. 2.

FIG. 8 is a spectral chart of an example light source.

FIG. 9 is a spectral chart of the example light source of FIG. 8 with an infrared light filter.

FIG. 10 is a spectral chart of the example light source of FIG. 8 with a visible light filter.

FIG. 11 is an example method for infrared background replacement.

FIG. 12 shows steps included in the calibration operation of the method shown in FIG. 11.

FIG. 13 shows steps included in the image capture operation of the method shown in FIG. 11.

FIG. 14 shows steps included in the image processing operation of the method shown in FIG. 11.

FIG. 15 shows steps included in the mask generation operation of the method shown in FIG. 14.

FIG. 16 illustrates an example spatial weighting array used in the method shown in FIG. 15.

FIG. 17 illustrates an example tile used in the method shown in FIG. 15.

FIG. 18 shows steps included in the composite image generation operation of the method shown in FIG. 14.

FIG. 19 is an example infrared image captured during the method shown in FIG. 11.

FIG. 20 is an example visible light image captured during the method shown in FIG. 11.

FIG. 21 is an example mask generated from the infrared image of FIG. 19 during the method shown in FIG. 11.

FIG. 22 is an example background used during the method shown in FIG. 11.

FIG. 23 is an example composite image resulting from the method shown in FIG. 11.

### DETAILED DESCRIPTION

Various embodiments will be described in detail with reference to the drawings, wherein like reference numerals represent like parts and assemblies throughout the several views.

In various applications, it is desirable to customize the background of the image behind the subject. One method is to generate a mask based on a background-illuminated image, where the subject is not illuminated. Then, that mask is effectively placed over the subject in the subject-illuminated image and the background is removed. However, that method does not compensate for subject motion. Oftentimes, a subject is in motion throughout a photography session or sit. For instance, many small children do not remain perfectly still for portraits. Animals may be in motion as well during image capture. Additionally, sometimes it is desirable to have the subject in action, such as a person jumping or a fan blowing a person's hair.

Generally, most digital single lens reflex (DSLR) cameras can capture up to ten frames per second. This image capture rate is too slow to produce two images without subject motion. Mirrorless digital cameras currently have frame rates of up to sixty images captured per second. Even with images captured at a rate of sixty per second, subject motion may still be noticeable and therefore can cause inaccurate background replacement. It is with respect to this general environment that the instant disclosure is directed.

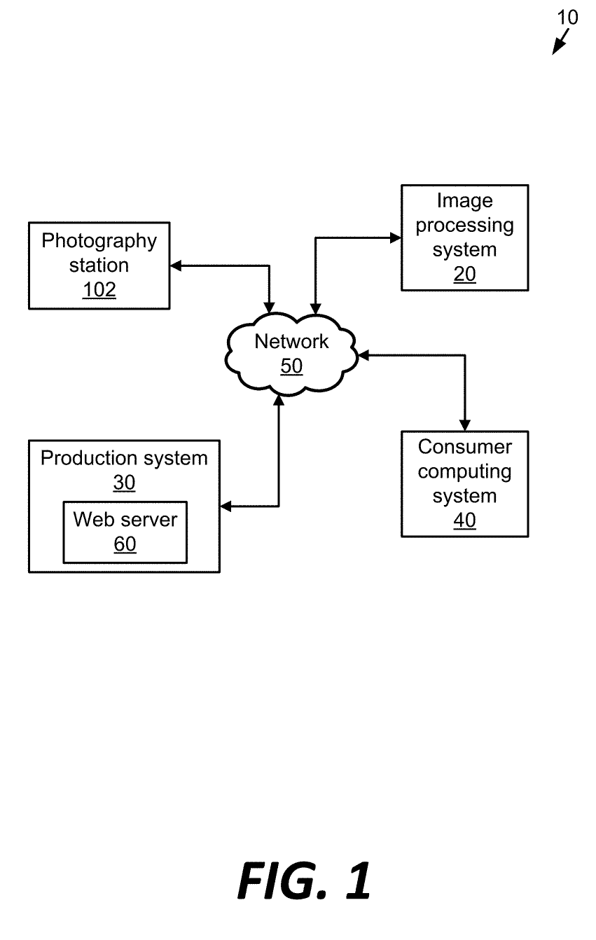

FIG. 1 is a schematic block diagram of an example system 10 for producing photographs. In the example, system 10 includes photography station 102, image processing system 20, production system 30, consumer computing system 40, and network 50. The system 10 is used to capture and produce one or more images of a subject. Example subjects include humans, animals, plants, and products or other objects. Other example systems can include more or fewer components.

Photography station 102 is used by a photographer to capture digital photographs of subjects. As described in more detail below, photography station 102 produces two frames of a subject for each captured image: a visible light frame and an infrared light frame. Generally, photography station 102 includes structure for photographing a subject with a digital camera and producing digital images.

In some instances, photography station 102 is a permanent or semi-permanent photography studio, such as a professional photography studio. Alternatively, photography station 102 is a mobile photography studio, which is portable so that it can be setup at a remote location, such as in a school, church, or other building or location. Outdoor installations of photography station 102 are possible. Typically, the photography station includes subject background, lighting units, and at least one camera. An example photography station 102 is shown and described in more detail below.

After one or more digital images have been captured, the image data is stored in a computer readable medium. Examples of computer readable media include memory cards (discussed above), a compact disc (CD), a digital versatile disc (DVD), a hard disc of a hard disc drive, or other types of computer readable media.

Image data are transferred to an image processing system 20. For example, the computer readable medium is brought to the image processing system 20, or is transported through a mail delivery system. In other embodiments, image data are transferred across network 50. Network 50 is a digital data communication network, such as the Internet, a local area network, a telephone network, or a smart phone network.

Image processing system 20 receives and processes the image data to generate a mask and subject image data. Example methods for processing image data are described below. The mask and subject image data are subsequently used for further processing, such as to remove a background from an image of the subject and insert a different background behind the subject.

Image processing system 20 can additionally perform various transformations to the image data. Example transformations include color correction, dust correction, brightness correction, definition of a cropping location, cropping, tilting, and/or other desired transformations or combinations of transformations. For ease of discussion, the resulting photos after processing by image processing system 20 are termed “processed image data”.

After processed image data has been generated, it is provided to production system 30, which uses the processed image data to produce one or more products. Example products include marketing or promotional material, photo mugs, picture books, photographs, computer-readable medium storing digital image data, and digital images delivered across network 50. Other examples of products include a composite product (composed of multiple different images), a photo mouse pad, a collage, a key tag, a digital picture frame or digital key chain, a photo card (such as a student identification card, driver's license, holiday or greeting card, security badge, baseball or other sports card, luggage tag, etc.), a photo magnet, an ornament, a puzzle, a calendar, a tote bag, a photo keepsake box, a t-shirt, an apron, or a variety of other products including a photographic image.

In some embodiments, production system 30 includes a web server 60 that is configured to communicate data across network 50, such as to send products in the form of digital data to consumer computing system 40. For example, web server 60 is in data communication with network 50 and hosts a web site. A customer uses consumer computing system 40 to communicate across the network 50 and access the web site, such as by using a browser software application operating on the consumer computing system 40. In some embodiments the customer can purchase products through the web site, or can access products that were previously purchased. The products can then be downloaded to consumer computing system 40, where they are stored in memory. In some embodiments the products continue to be hosted on web server 60, but the customer is provided with links that can be inserted into the customer's own web pages or on third party web sites (e.g., Facebook, Instagram, etc.) to allow others to view and/or download the products.

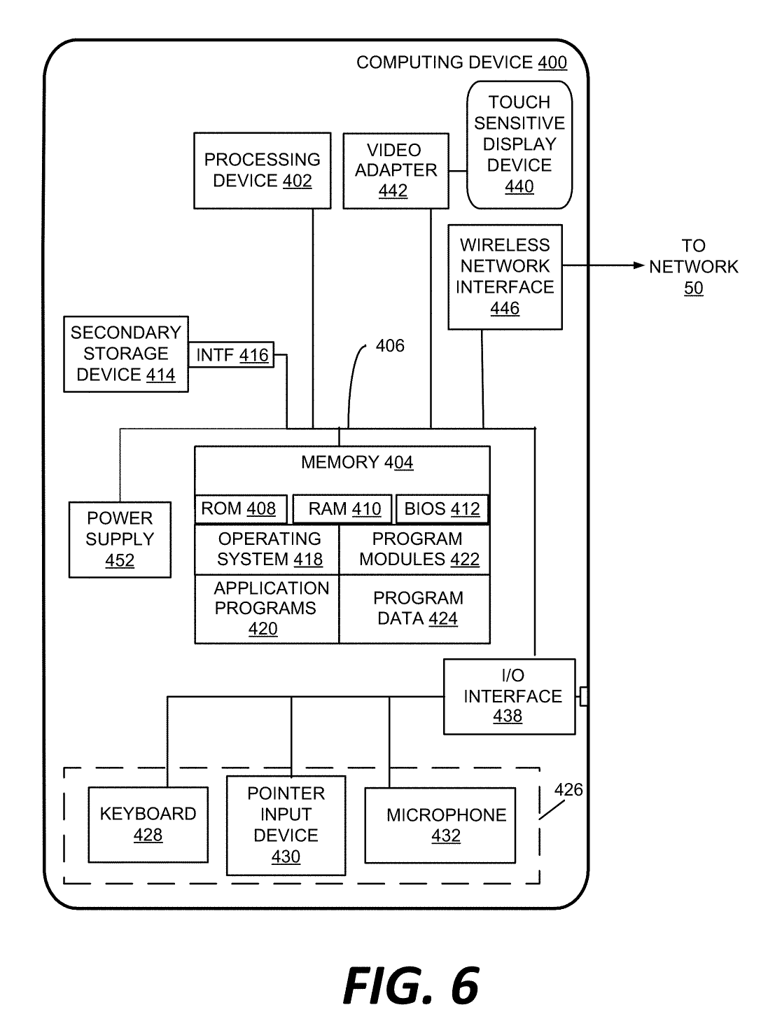

An example of consumer computing system 40 is computing device 400, illustrated and described with reference to FIG. 6 below. Some embodiments include consumer computing system 40 in the form of a smart phone, a laptop computer, a handheld computer, a desktop computer, or other computing systems.

Photography described herein typically relates to image capture for a particular pose. An example photo hierarchy includes a photo session, a sit, and image capture during a pose. The broadest category is a photo session. The photo session 604 includes all the photos taken by one or more photographers at a particular site. The site is a school, club, church, field, photo studio, mall, or other location.

The sit includes the photos taken for a particular subject, where the subject is a person, more than one person, a product, or other inanimate object. Each sit includes one or more poses. A pose is a particular positioning, movement or angle of the subject. For example, one pose for a human subject is that person standing, a different pose is that person sitting, another pose is that person jumping, and still another pose is that person sitting with arms crossed. That is, a pose includes non-stationary movement. Additionally, the camera angle or zoom can be varied between poses. One or more images are captured during each pose.

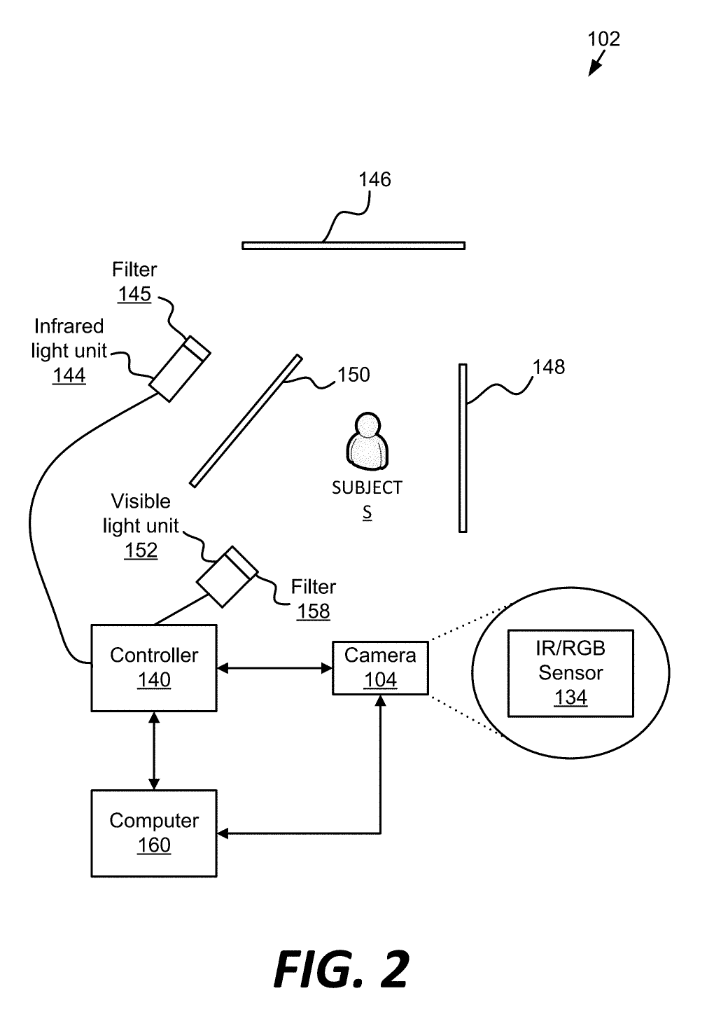

FIG. 2 is a block diagram of an example photography station 102. The embodiment shown includes subject S positioned in front of camera 104, where camera 104 is in communication with controller 140 and computer 160. Camera 104 includes infrared/visible light (“IR/RGB”) sensor 134. Controller 140 is also in communication with infrared light unit 144 and visible light unit 152. Example photography station 102 also includes background 146, fill reflector 148, light block 150, and visible light unit 152. Other embodiments can include more or fewer components. The angles, sizes and relative positioning between components in FIG. 2 are not meant to be limiting.

Example photography station 102 is typically used by a professional photographer to capture one or more photographs of subject S. Subject S is a person, animal, object, or a combination thereof. Typically, the professional photographer uses computer 160, such as a laptop or tablet computing device, arranged near camera 104 to perform various activities related to photographing subject S. Example activities include barcode scanning, verifying identity, and adjusting zoom, lighting, and other parameters.

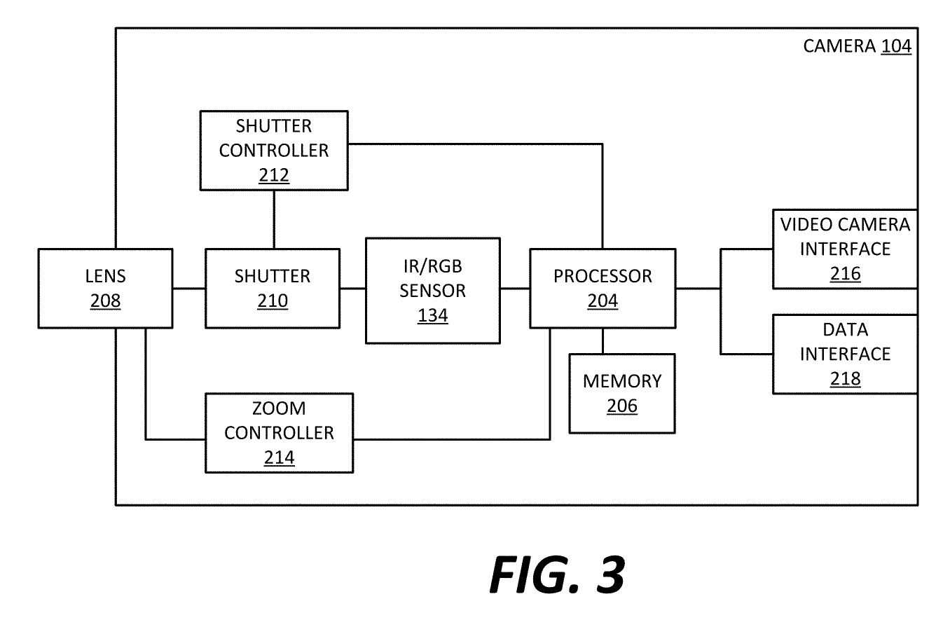

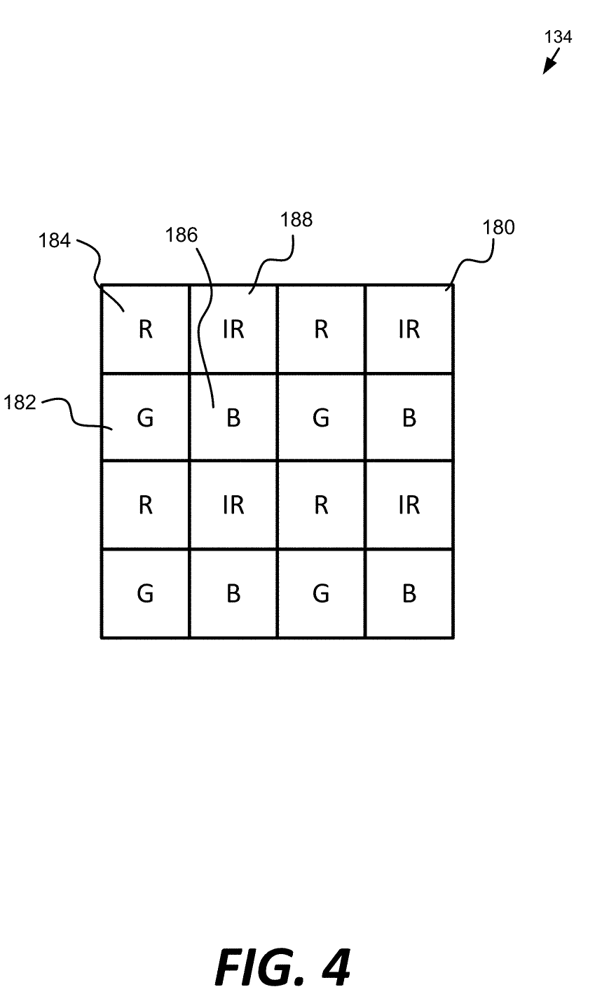

Camera 104 is a device that operates to capture an image of subject S. Camera 104 is in wired or wireless communication with controller 140 and computer 160. Typically, camera 104 is a digital camera including RGB-IR sensor. RGB-IR sensor 134 enables camera 104 to capture both infrared and visible light images simultaneously. Because the same image sensor is used to capture both infrared and visible light, the subject S is aligned in the resulting infrared and visible light images. Details about camera 104 are shown and described with reference to, at least, FIGS. 3-4.

Generally, computer 160 and/or controller 140 coordinate image capture by camera 104 with infrared light unit 144, 152 operation. As shown, controller 140 and computer 160 are separate components, however, in alternate implementations controller 140 and computer 160 are integral. In addition to the coordinating image capture, computer 160 also performs some initial processing on digital images received from camera 104 (such as to associate metadata with the digital images).

A photographer can use a remote control device (not shown) that is in communication with controller 140 to initiate image capture. In various implementations, the remote control device is in wired or wireless communication with controller 140. For example, the remote control device can communicate with controller 140 via infrared signal emission, radio frequency, Bluetooth, Wi-Fi, and other wireless communication protocols known in the art. The remote control device can be a separate physical component with one or more buttons, an interface on a smart computing device such as a smart phone, and a button integrated into camera 104.

Infrared light unit 144 is configured to illuminate background 146 with infrared light during image capture. As used herein, “infrared light” includes light having a wavelength of 700 nm to 1400 nm. Infrared light unit 144 can be configured to emit infrared light through the use of filter 145.

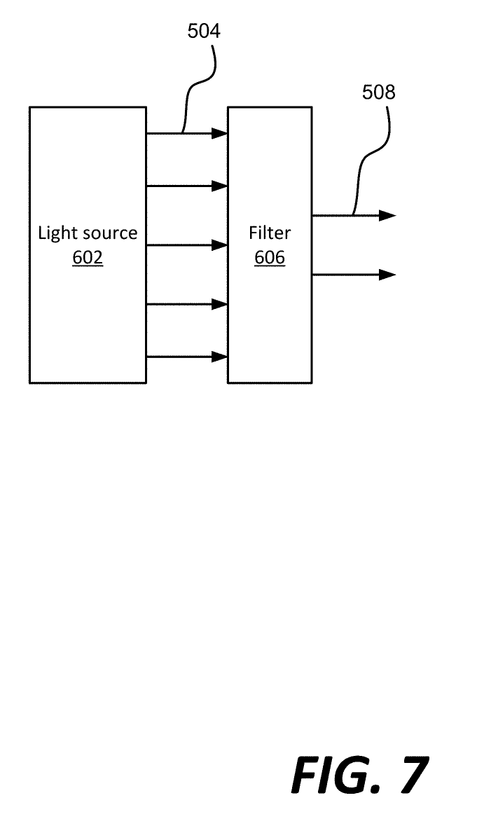

Referring for the moment to FIG. 7, FIG. 7 is a schematic diagram of a light source 602 and a filter 606. Light source 602 emits light 504 in a given wavelength range. Filter 606 selectively blocks some of the emitted light 504 and only allows certain wavelengths of light 508 to pass through.

For infrared light unit 144, filter 145 blocks most or all of the light emitted from the lighting components of IR light unit 144 that is the visible light spectrum (essentially, light having a wavelength between 400 nm-700 nm).

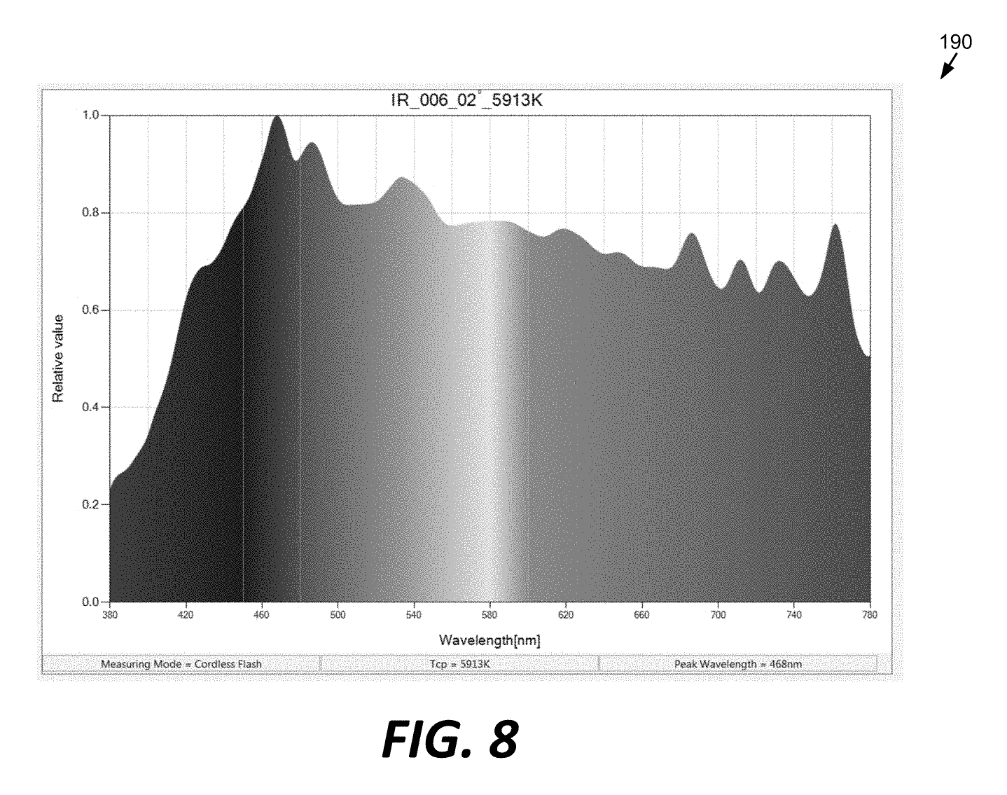

FIG. 8 shows an example spectral chart 190 for a light source possibly used in infrared light unit 144. As shown, the light source emits light throughout the spectrum from 380 nm to 780 nm. That is, the light source emits both visible and infrared light.

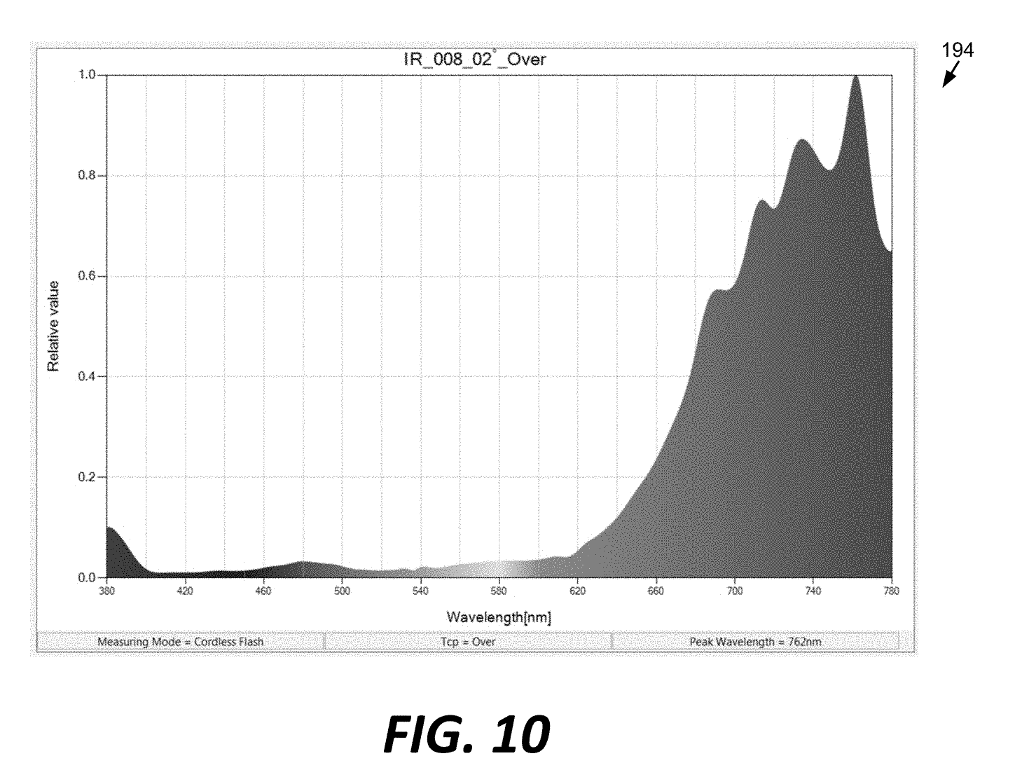

Filter 145 limits or eliminates visible light emitted from infrared light unit 144. The spectral chart 194 in FIG. 10 shows an example filter 145 applied to infrared light unit 144. As shown in FIG. 10, filter 145 eliminates most visible light having a wavelength less than 620 nm, and much of the visible light having a wavelength between 620 nm and 700 nm. The infrared light is allowed to pass through filter 145.

Filter 145 can be integral with, adhered to, or placed in front of infrared light unit 144. Examples of filter 145 include one or more layers of visible light-blocking paint, a plastic cap that allows IR light to pass through, and a visible light-blocking film. In some instances, infrared light unit 144 is sold commercially with a visible light-blocking coating that acts as filter 145.

Preferably infrared light unit 144 illuminates background 146 with infrared light evenly during image capture. In various implementations, infrared light unit 144 illuminates background 146 with flash or continuous illumination. Even illumination of background 146 can be accomplished by, for example, proper positioning of infrared light unit 144.

In some circumstances, it may be desirable to remove an object from an image in addition to, or instead of, replacing the background. In those circumstances, photography station 102 includes one or more additional infrared light units (not shown) positioned to illuminate the foreground objects with infrared light during image capture.

Typically, infrared light unit 144 includes one or more stands to support and elevate the light sources. In addition, the infrared light unit 144 can include one or more light modifiers, such as an umbrella or soft box, which diffuses the light from the light source to provide the desired lighting pattern and distribution.

In an alternative embodiment, infrared light unit 144 can also be implemented as a panel of IR-light emitting diodes (LEDs). Because IR LEDs emit light in the IR spectrum, there is no need for filter 145 in implementations having IR LEDs in infrared light unit 144.

Light block 150 prevents most or all of the light from infrared light unit 144 from illuminating the subject. The background lights are oriented substantially orthogonal to the background 146, although other angles can be used. The infrared light unit 144 and light block 150 are positioned such that they do not appear in the image captured by camera 104.

Background 146 is arranged in line with subject S and camera 104 to provide a backdrop for images captured by camera 104. Background 146 typically has an exterior surface having a color, pattern, and/or material that evenly reflects infrared light. For example, background 146 has a substantially non-textured, dark gray surface. In other instances, background 146 surface can be textured and be of different colors.

Background 146 typically includes a frame or stand that supports the background material having the exterior surface. In some embodiments, the background material is substantially opaque, while in other embodiments the background material is translucent. For example, in some embodiments the infrared light unit 144 is configured to directly illuminate a rear surface of the background material, and light from the infrared light unit 144 passes through the translucent background material, so that it is visible on the exterior surface.

In other embodiments, however, the background 146 is a separate object that is not a part of the photography station 102. Examples of such backgrounds 146 include a wall, a curtain, a whiteboard, or other structure having an exterior surface that can be illuminated by infrared light unit 144.

Fill reflector 148 is a screen, panel, light or a substantially flat surface such as a wall. Fill reflector 148 can have low to medium reflective qualities. Generally, pure reflective surfaces, such as a mirrored surface, are not used as a fill reflector. Fill reflector 148 is substantially monochrome and can be a white, off-white or gray color. The fill reflector 148 is a way to provide soft light on one side of the subject to eliminate, or significantly reduce, shadowing on the subject. In the arrangement shown in FIG. 2, visible light unit 152 is positioned generally to the right of the subject. In that arrangement, some of the light from visible light unit 152 reflects off the fill reflector 148 and onto the left side of the subject.

Visible light unit 152 provides visible light illumination of the subject S during an image capture. Visible light unit 152 can include one or more light sources and additional lighting components, such as a fill lighting system. Additionally, visible light unit 152 emits light as flash, not continuous, illumination. This is particularly in contrast to lighting used during film (movie) production. Visible light unit 152 can additionally include filter 158 configured to filter out infrared light. Optionally, visible light unit 152 is a light source that does not emit infrared light.

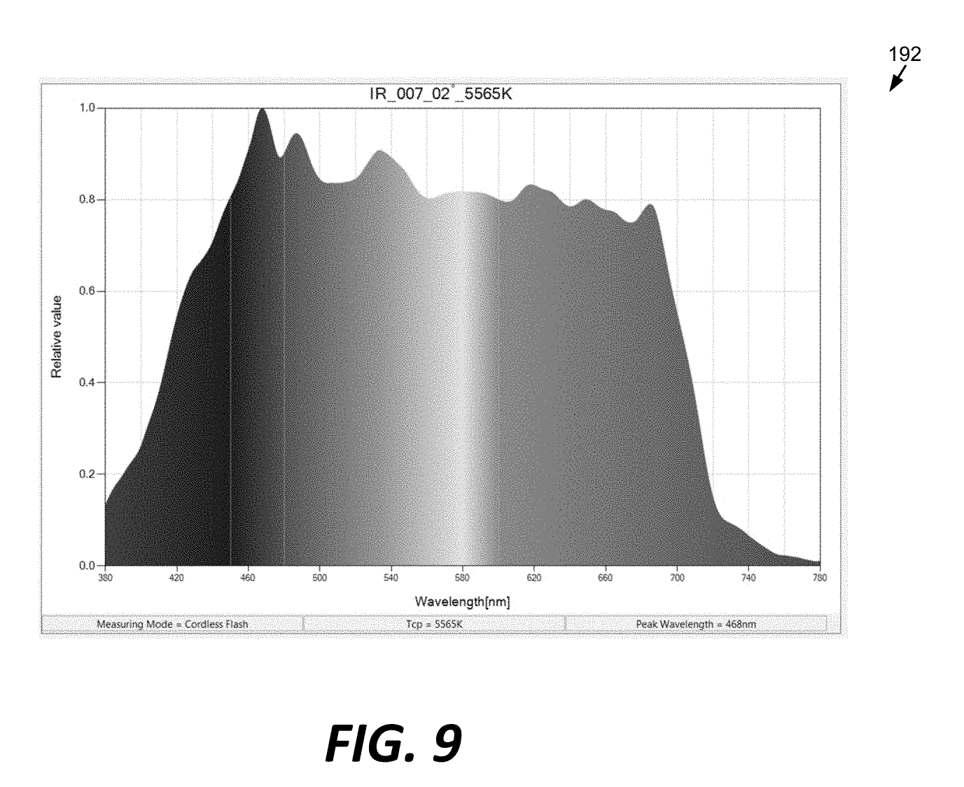

FIG. 8 shows an example spectral chart 190 for a light source possibly used in visible light unit 152. As shown, the light source emits light throughout the spectrum from 380 nm to 780 nm. That is, the light source emits both visible and infrared light. Filter 158 can be applied to visible light unit 152 to limit or eliminate the infrared light emitted from visible light unit 152. The spectral chart 192 in FIG. 9 shows an example filter 158 applied to visible light unit 152. There, filter 158 eliminates most infrared light having a wavelength greater than 740 nm, and much of the infrared light having a wavelength between 700 nm and 740 nm.

A variety of different light sources can be used for visible light unit 152, such as incandescent, fluorescent, high-intensity discharge, and light emitting diode light sources. The controller 140 operates to control the flashing of the visible light unit 152 during image capture.

Typically, visible light unit 152 includes one or more stands to support and elevate the light sources. In addition, visible light unit 152 can include one or more light modifiers, such as an umbrella or soft box, which diffuses the light from the light source to provide the desired lighting pattern and distribution.

FIG. 3 is a schematic block diagram of an example camera 104. Camera 104 is a digital camera including RGB-IR (“red, green, blue and infrared”) sensor 134 for converting an optical image to an electric signal, processor 204 for controlling the operation of the camera 104, and memory 206 for storing the electric signal in the form of digital image data. Other components shown in the example include lens 208, shutter 210, shutter controller 212, zoom controller 214, video camera interface 216, and data interface 218. Various implementations can include more or fewer components.

RGB-IR sensor 134 receives light from a subject and background and converts the received light into electrical signals. The signals are converted into a voltage, which is then sampled, digitized, and stored as digital image data in memory 206. An example RGB-IR sensor 134 is shown in FIG. 4.

RGB-IR sensor 134 is a deviation from a traditional complementary metal-oxide semiconductor (CMOS) image sensor. Traditional CMOS image sensors employ a Bayer color filter array (CFA). The Bayer CFA allows each pixel of the CMOS sensor to be excited by a specified wavelength of light—typically corresponding to the color wavelengths of red, green and blue. In a typical Bayer CFA, there will be 50% green pixels, 25% red pixels and 25% blue pixels.

In the RGB-IR sensor 134, the CFA has been modified. Sensor array 134 is arranged in four-pixel groups that repeat over the entirety of the sensor and include green pixels 182, red pixels 184, blue pixels 186, and IR pixels 188. That is, the Bayer CFA sensor array is modified in RGB-IR sensor 134 to pass infrared light only (no visible light) to one pixel 180 out of four in every four-pixel group. In the RGB-IR format of sensor array 134, there are 25% green pixels 182, 25% red pixels 184, 25% blue pixels 186, and 25% IR pixels 188. Thus, half of the green pixels in the Bayer CFA are converted to an IR pixel in RGB-IR sensor 134. Other configurations of RGB-IR sensor 134 are possible.

That said, in Bayer CFA format, even though there are no pixels for infrared, all red, green and blue pixels will be sensitive to their respective color wavelengths and also for infrared wavelengths. Hence in Bayer CFA sensors, an infrared cut-off filter is typically used to avoid the direct influence of infrared over other colors. In the RGB-IR format, all the pixels are sensitive to Infrared light, except that the IR pixels are sensitive only to Infrared light.

Referring again to FIG. 3, memory 206 can include various forms of computer readable storage media, such as random access memory. In some embodiments, memory 206 includes a memory card. A wide variety of memory cards are available for use in various embodiments. Examples include: a CompactFlash (CF) memory card (including type I or type II), a Secure Digital (SD) memory card, a mini Secure Digital (miniSD) memory card, a micro Secure Digital (microSD) memory card, a smart media (SM/SMC) card, a Multimedia Card (MMC), an xD-Picture Card (xD), a memory stick (MS) including any of the variations of memory sticks, an NT card, and a USB memory stick (such as a flash-type memory stick). Other embodiments include other types of memory, such as those described herein, or yet other types of memory.

Lens 208 is located in front of shutter 210 and is selectably adjusted to provide the appropriate photographic characteristics of light transmission, depth of focus, etc. Shutter 210 can be mechanical, electrical, or both. In some embodiments, lens 208 is selected between 50 and 250 mm, with the image taken at an f-stop generally in the range of f16 to f22; in the range of f4 to f16; or in the range of f4 to f22. This provides a zone focus for the image. It also generally eliminates concerns regarding ambient light. However, it will be appreciated that any number of lenses, focusing, and f-stops may be employed in connection with the present invention.

An image capture button is used to initiate image capture. The image capture button can be positioned on a remote control device, camera 104, controller 140, and/or computer 160. When selected, the image capture button generates a shutter release signal that is communicated to shutter controller 212 of camera 104.

Zoom controller 214 is also provided in some embodiments to mechanically adjust lens 208 to cause the camera 104 to zoom in and out on a subject. Controls for adjusting the zoom can be included on a remote control device, camera 104, controller 140, and/or computer 160. Signals from the aforementioned devices are communicated to the controller 140, which communicates the request to zoom controller 214 of camera 104. The zoom controller 214 typically includes a motor that adjusts lens 208 accordingly.

Camera 104 can include video camera interface 216 and data interface 218. Video camera interface 216 communicates live video data from camera 104 to one or more of the components in photography station 102. For instance, video camera interface 216 communicates live video data from camera 104 to computer 160 or controller 140.

Data interface 218 is a data communication interface that sends and receives digital data to communicate with another device in photography station 102, such as controller 140 or computer 160. For example, the data interface 218 receives image capture messages from controller 140 that instruct camera 104 to capture one or more digital images. Data interface 218 is also used in some embodiments to transfer captured digital images from memory 206 to another device, such as controller 140 or computer 160. Examples of video camera interface 216 and data interface 218 are USB interfaces. In some embodiments, video camera interface 216 and data interface 218 are the same, while in other embodiments they are separate interfaces.

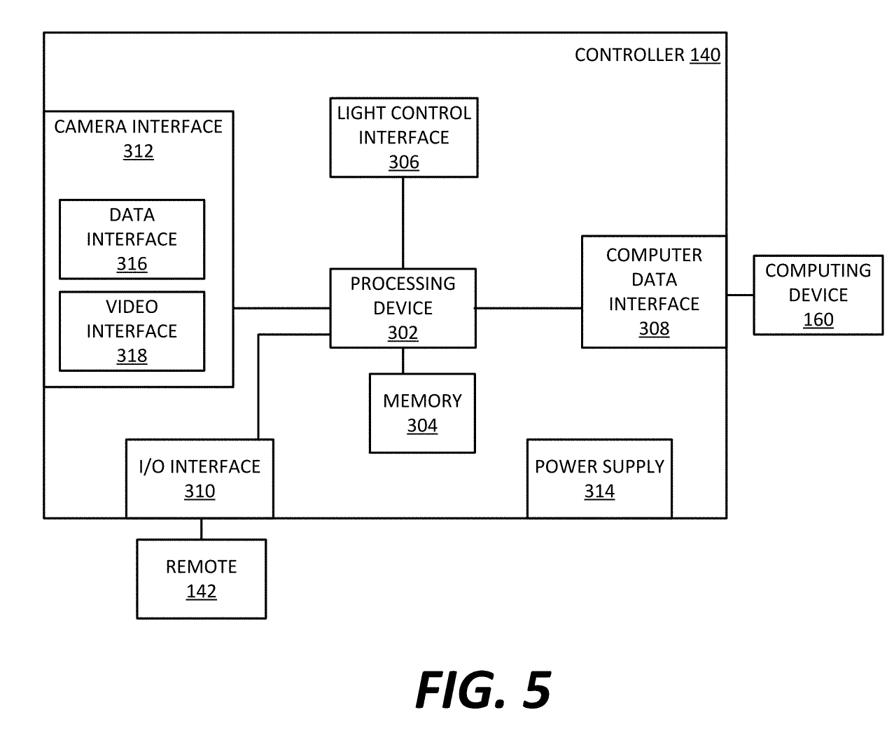

FIG. 5 is a schematic block diagram of an example controller 140. In this example, controller 140 includes one or more processing devices 302, memory 304, light control interface 306, computer data interface 308, input/output interface 310, camera interface 312, and power supply 314. In some embodiments, camera interface 312 includes data interface 316 and video interface 318.

Processing device 302 performs control operations of controller 140, and interfaces with memory 304. Examples of suitable processors and memory are described herein.

Light control interface 306 allows controller 140 to control the operation of one or more lights, such as visible light unit 152 and infrared light unit 144 (shown in FIG. 2), and other lights. Connection between controller 140 and the various lighting components is wired and/or wireless. In some embodiments light control interface 306 is a send-only interface that does not receive return communications from the lights. Other embodiments permit bidirectional communication. Light control interface 306 is operable to selectively illuminate one or more lights at a given time. Controller 140 operates to synchronize the illumination of the lights with the operation of camera 104.

Computer data interface 308 allows controller 140 to send and receive digital data with computer 160. An example of computer data interface 308 is a universal serial bus interface, although other communication interfaces are used in other embodiments, such as a wireless or serial bus interface.

One or more input devices, such as remote 142, can be coupled to the processing device 302 through input/output interface 310. The input devices can be connected by any number of input/output interfaces 310 in various embodiments, such as a parallel port, serial port, game port, universal serial bus, or wireless interface.

Camera interface 312 allows controller 140 to communicate with camera 104. In some embodiments, camera interface 312 includes data interface 316 that communicates with data interface 218 of camera 104 (shown in FIG. 4), and a video interface 318 that communicates with video camera interface 216 of camera 104 (also shown in FIG. 4). Examples of such interfaces include universal serial bus interfaces. Other embodiments include other interfaces.

In some embodiments a power supply 314 is provided to receive power, such as through a power cord, and to distribute the power to other components of the photography station 102, such as through one or more additional power cords. Other embodiments include one or more batteries. Further, in some embodiments controller 140 receives power from another device.

Controller 140 is arranged and configured to synchronize the illumination of light units 144 and 152 with image capture, either through wired or wireless communication. In embodiments, controller 140 provides one or more triggers or pulses to the lights 144 and 152. In other embodiments, controller 140 communicates digital messages that are used to synchronize and control the various operations.

FIG. 6 illustrates an exemplary architecture of a computing device that can be used to implement aspects of the present disclosure, including camera 104, image processing system 20, production system 30, web server 60, and computer 160, and will be referred to herein as computing device 400.

Computing device 400 is used to execute the operating system, application programs, and software modules (including the software engines) described herein.

Computing device 400 includes, in some embodiments, at least one processing device 402, such as a central processing unit (CPU). A variety of processing devices are available from a variety of manufacturers, for example, Intel or Advanced Micro Devices. In this example, computing device 400 also includes a system memory 404, and a system bus 406 that couples various system components including the system memory 404 to the processing device 402. The system bus 406 is one of any number of types of bus structures including a memory bus, or memory controller; a peripheral bus; and a local bus using any of a variety of bus architectures.

Examples of computing devices suitable for computing device 400 include a desktop computer, a laptop computer, a tablet computer, a mobile device (such as a smart phone, an iPod® mobile digital device, or other mobile devices), or other devices configured to process digital instructions.

The system memory 404 includes read only memory 408 and random access memory 410. A basic input/output system 412 containing the basic routines that act to transfer information within computing device 400, such as during start up, is typically stored in the read only memory 408.

Computing device 400 also includes a secondary storage device 414 in some embodiments, such as a hard disk drive, for storing digital data. The secondary storage device 414 is connected to the system bus 406 by a secondary storage interface 416. The secondary storage devices and their associated computer readable media provide nonvolatile storage of computer readable instructions (including application programs and program modules), data structures, and other data for computing device 400.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 414 or memory 404, including an operating system 418, one or more application programs 420, other program modules 422, and program data 424.

In some embodiments, computing device 400 includes input devices to enable a user to provide inputs to computing device 400. Examples of input devices 426 include a keyboard 428, pointer input device 430, microphone 432, and touch sensitive display 440. Other embodiments include other input devices 426. The input devices are often connected to the processing device 402 through an input/output interface 438 that is coupled to the system bus 406. These input devices 426 can be connected by any number of input/output interfaces, such as a parallel port, serial port, game port, or a universal serial bus. Wireless communication between input devices and interface 438 is possible as well, and includes infrared, Bluetooth® wireless technology, 802.11a/b/g/n/ac, cellular, or other radio frequency communication systems in some possible embodiments.

In this example embodiment, a touch sensitive display 440 is also connected to the system bus 406 via an interface, such as a video adapter 442. The touch sensitive display 440 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

In addition to the display device 440, computing device 400 can include various other peripheral devices (not shown), such as speakers or a printer.

When used in a local area networking environment or a wide area networking environment (such as the Internet), computing device 400 is typically connected to the network 50 through a network interface, such as a wireless network interface 446. Other possible embodiments use other communication devices. For example, some embodiments of computing device 400 include an Ethernet network interface, or a modem for communicating across the network.

In some examples, computing device 400 includes a power supply 452 that provides electric power to several components and elements of computing device 400. Examples of the power supply 452 include AC power supplies, DC power supplies, and batteries, either disposable or rechargeable.

Computing device 400 typically includes at least some form of computer-readable media. Computer readable media includes any available media that can be accessed by computing device 400. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by computing device 400.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

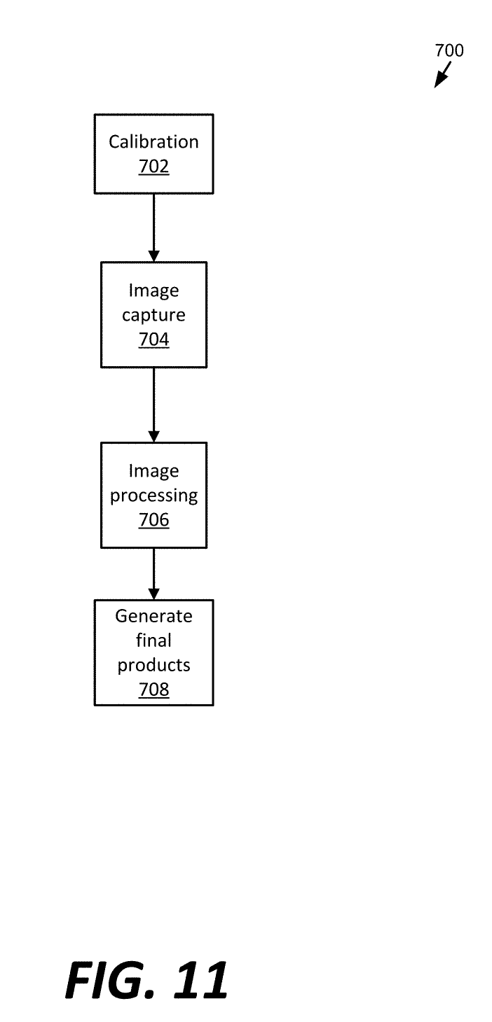

FIG. 11 is an example flowchart of a method 700 for infrared background replacement. The example method 700 includes calibrating (operation 702), image capturing (operation 704), image processing (operation 706), and generating final products (operation 708). Generally, system 10, described above, is used for performing some or all operations of example method 700. In some instances, various operations in example method 700 are not necessary. For example, calibration operation 702 might only be performed once per photo session. Other embodiments can include more or fewer operations.

The example method 700 begins by calibrating (operation 702) the photography system. In a typical environment, infrared light is emitted from various peripheral or environmental sources. Examples include sunlight and lighting in the photography room and/or adjacent rooms. One purpose of calibration operation 702 is to account for the infrared light that the image sensor will detect that is not part of the photography station.

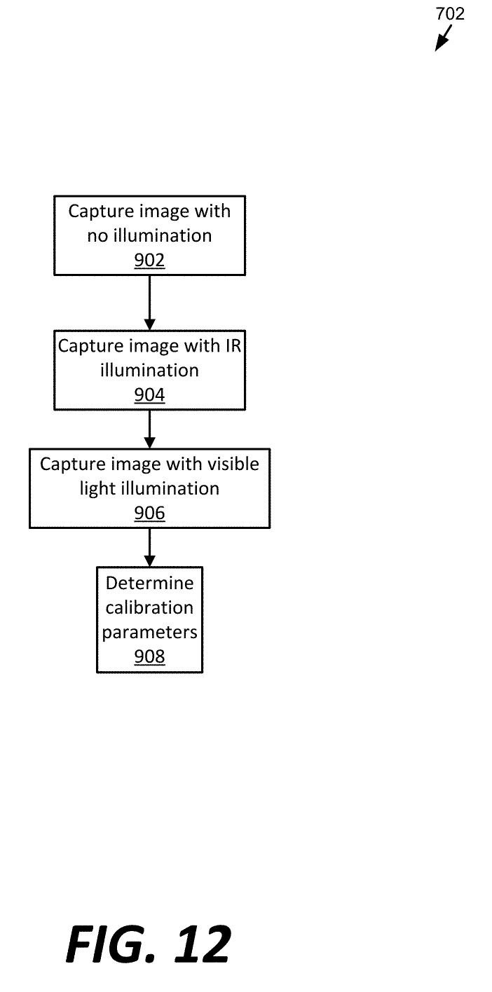

Referring to FIG. 12, calibrating (operation 702) includes capturing an image with no illumination (operation 902), capturing an image with infrared illumination (operation 904), capturing an image with visible light illumination (operation 906), and determining calibration parameters (operation 908). In some instances, calibration (operation 702) can be performed with more or fewer operations shown in FIG. 12.

First, an image of a subject, which may or may not be one of the subjects of interest, is captured without illumination of any lighting units (operation 902). For example, a mannequin can be used to prepare for a photo session at a school. Images are also captured with infrared light illuminating the background (operation 904), preferably from the infrared lighting units that are part of photography station 102. During operation 904, it is preferable that none of the visible light units are illuminated during image capture.

Additionally, images are captured with one or more of the visible light units illuminated (operation 906). During operation 906, it is preferable that none of the infrared light units are illuminated.

Next, operation 908 includes determining calibration parameters. Determining calibration parameters (operation 908) includes analyzing each image captured during operation 702, which can include one, two, or three image captures. In particular, analysis of the images can include determining an amount and/or spatial distribution of infrared light emitted by the visible light unit. In some environments, infrared light contributed by ambient lighting and/or the visible light unit(s) may not be evenly distributed across the background, where some portions of the background reflect more infrared light than others. Calibration parameters determined during operation 908 can be used during image post-processing.

For example, an image captured when no lighting units are illuminated is analyzed to determine how much ambient lighting contributes to infrared light on the background. Next, an image captured when the visible light unit is illuminated is analyzed to determine the amount, and distribution, of infrared light on the background. Then, the amount of infrared light on the background can be accounted for when subject images are processed to create the mask.

Images captured with only the infrared light unit illuminated can also be used during calibration. For instance, the amount and distribution of infrared light on the background with no illumination can be used subtracted from the amount and distribution of infrared light on the background with the infrared light unit illuminated.

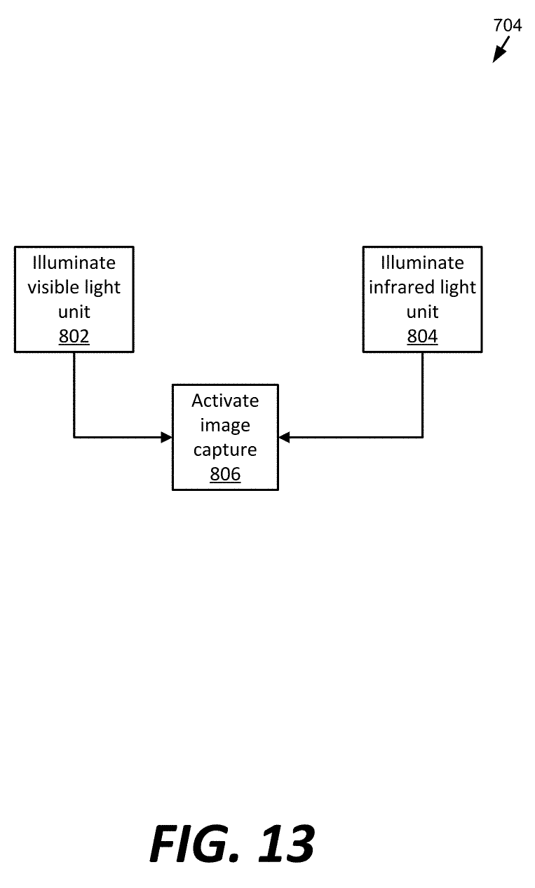

Referring now to FIG. 13, steps involved in image capturing (operation 704) are provided. These steps include illuminating a visible lighting unit (operation 802), illuminating an infrared light unit (operation 804), and activating image capture (806). As described in other parts of this disclosure, a single image is captured by an image sensor array having both visible light and infrared light sensors. Therefore, the subject and background are simultaneously illuminated with visible light and infrared light, respectively.

Illuminating the infrared light unit (operation 804) can be done continuously or as a flash. The visible light unit is typically illuminated (operation 802) with a flash corresponding to the timing of image capture. As described in more detail above, controller 140 coordinates the illumination of visible light unit, infrared light unit, and image capture by image sensor array 134.

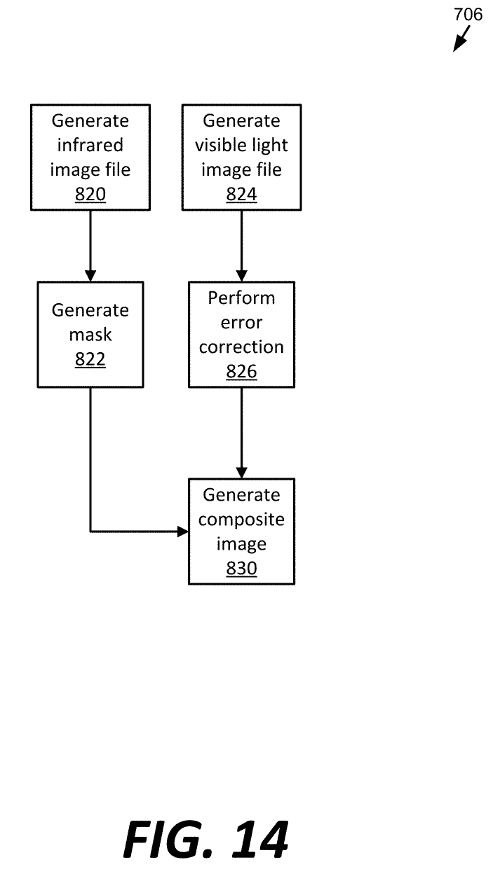

After the image has been captured (operation 704), the image is processed (operation 706). Referring to FIG. 14, example operations in image processing (operation 706) are provided. In some instances, the operations shown can proceed in parallel.

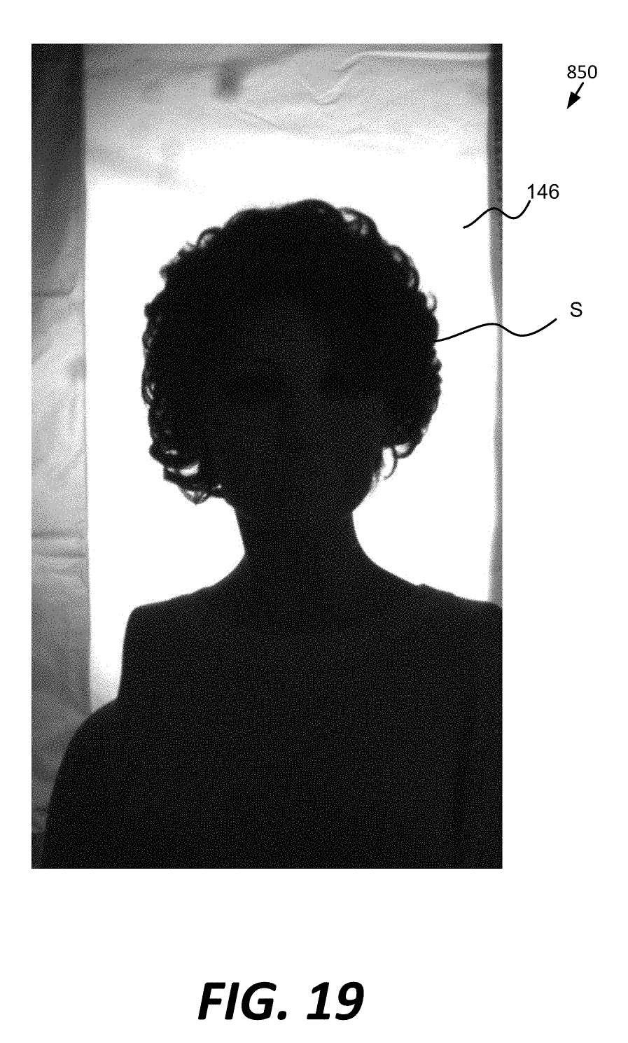

Upon receiving the image, two image files are generated: an infrared image and a visible light image. Generating the infrared image file (operation 820) includes obtaining the read-out from the infrared sensors of image sensor array 134. An example infrared image 850 is shown in FIG. 19.

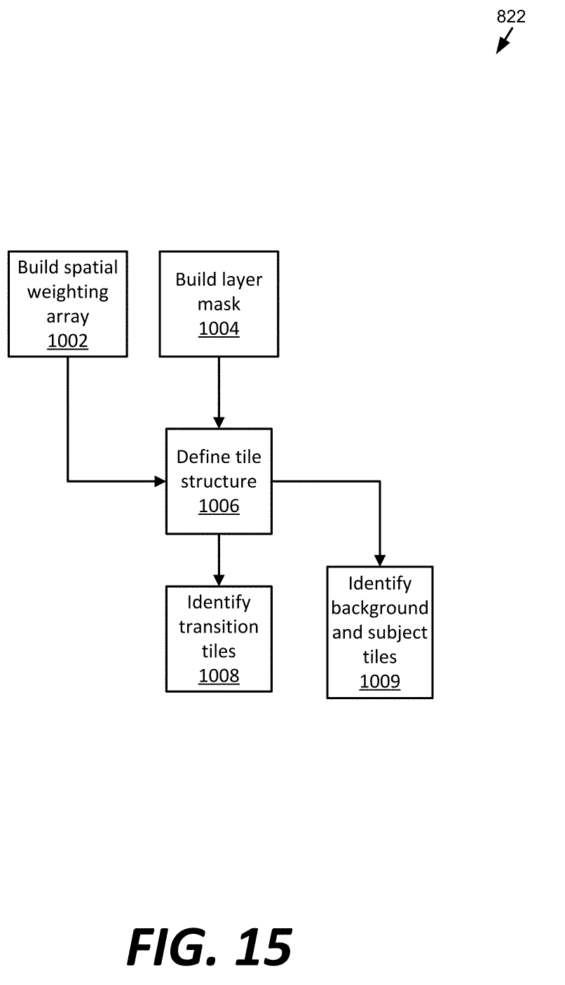

In theory, because only the background is illuminated with infrared light, the IR sensors in the image sensor array cause the background to appear as lighted up in infrared image 850. Again, in theory, the subject is only illuminated with visible light and visible light is blocked from the IR sensors in image sensor array 134. Accordingly, the subject appears dark in infrared image 850. The infrared image file is used to generate a mask (operation 822). In some embodiments the mask is a file that identifies each pixel as being one of: a background region, a subject region, or a boundary region. Mask generation is discussed in more detail below with references to FIGS. 15-18.

The infrared image encodes an image of the subject captured under lighting conditions in which the subject was illuminated with visible light and the background was illuminated with infrared light. The infrared image file contains pixel values representing a brightness of infrared light detected at each of the pixel locations. For example, a value of 0 can represent a completely dark pixel in which no infrared light was detected and a value of 255 can represent a completely bright pixel in which a maximum detectable amount of infrared light was detected. In this way, the background region of the image, which was illuminated by an infrared light source, is represented by values for bright pixels and the subject region, which was largely masked from illumination by infrared light, is represented by values for dark pixels. Additionally, boundary regions between the subject and the background (including any partially transparent or translucent regions of the subject) are represented by values between the bright and dark pixel values.

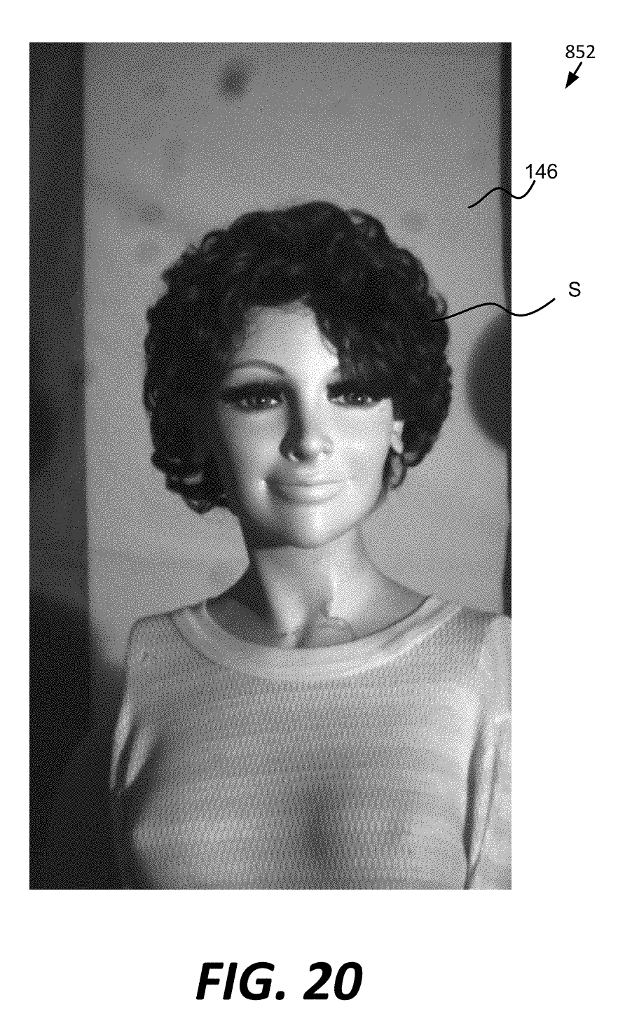

Generating the visible light image file (operation 824), includes obtaining the read-out from the red, green, and blue sensors in image sensor array 134. An example visible light image 852 is shown in FIG. 20. Because some visible light passes beyond the subject S, both the background 146 and subject S appear lighted in visible light image 852, although subject S should be lighted more so than background 146.

Upon generating the visible image file (operation 824) and infrared image (operation 820), error correction algorithms are typically applied to account for any artifacts resulting from image capture with image sensor array 134. An example error correction method is described in High Resolution Photography with an RGB-Infrared Camera by Tang et. al, the entirety of which is hereby incorporated by reference.

After generating the mask (operation 822) and performing erorr correction (operation 826) a composite image is generated (operation 830). Generating a composite image (operation 830) is discussed at least with reference to FIG. 19 in more detail below.

FIG. 15 is an example embodiment of a method 822 for generating a mask. The example method 822 includes building a spatial weighting array (operation 1002), building a masks (operation 1004), defining tile structure (operation 1006), identifying transition tiles (operation 1008), and identifying background and subject tiles (operation 1009). Other embodiments can include more or fewer operations.

In this example, the generating a mask method 822 begins by building a spatial weighting array (operation 1002). In fact, operation 1002 can be performed before any images are captured. Additionally, the same spatial weighting array can be used for generating more than one composite mask. The spatial weighting array is a two-dimensional filter that has a minimum value at its center and a maximum value at its edges. An example spatial weighting array 1050 is shown in FIG. 9. Other types of filters can be used.

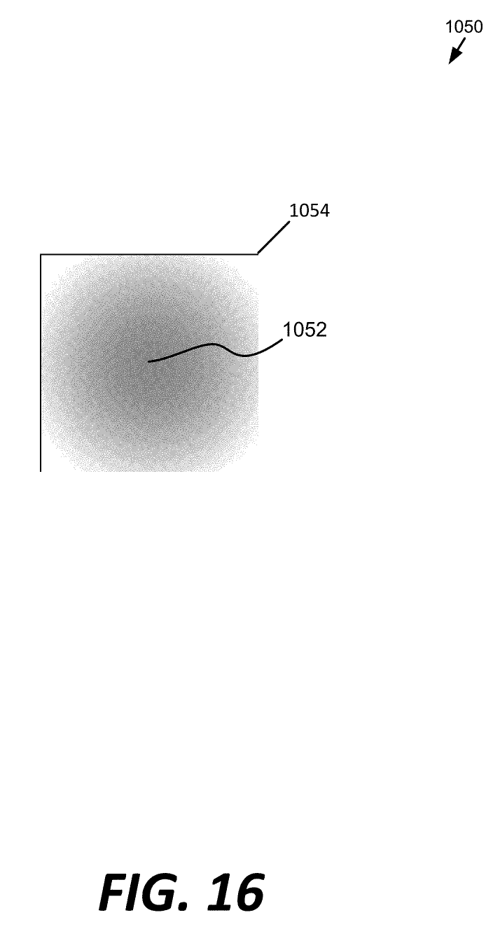

As seen in FIG. 16, the spatial weighting array 1050 is square. Other shapes are possible. The lowest value, 1 in example array 1050, is at the centroid 1052 of the spatial weighting array 1050. The highest value, 2, is at the corners 1054 of the spatial weighting array 1050. Other minimum and maximum values can be used, for example, 0.001 for the minimum and 1 for the maximum, or 1 for minimum and 100 for the maximum. Other values for the minimum and the maximum are possible. In the embodiment shown, the values increase linearly for each concentric circle around the centroid 1052 of the spatial weighting array 1050. Alternatively, the values increase in a non-linear fashion away from the centroid 1052 of the spatial weighting array 1050.

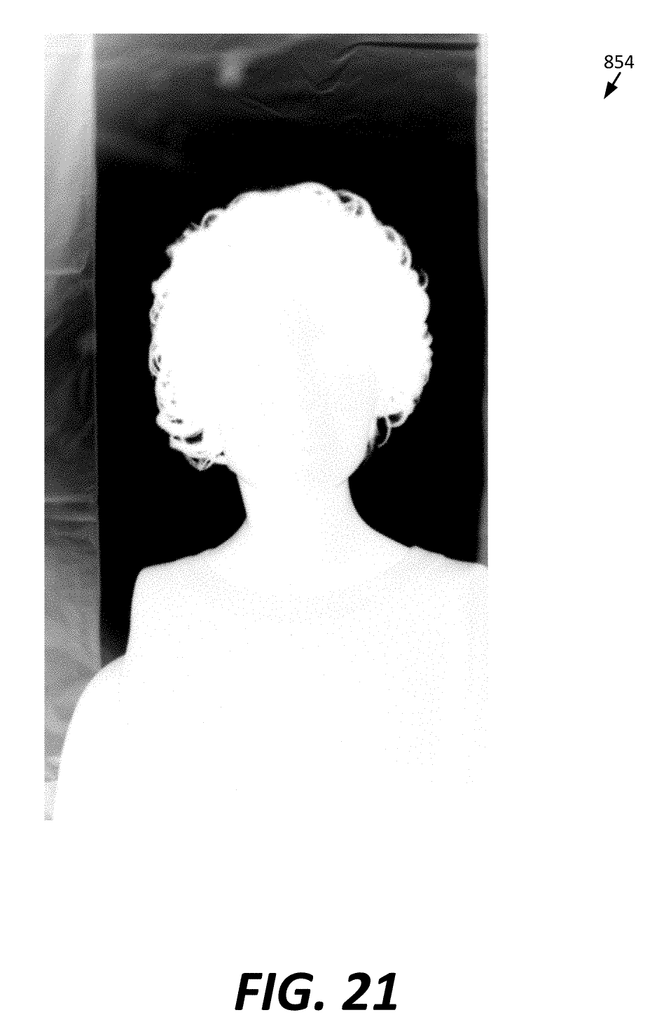

The example method 822 also begins by building layer masks (operation 1004) from the infrared images generated in operation 820. Generally, the layer masks are a separate file created based on a captured image, where each pixel in the captured image is assigned a brightness value from 0 to 255 in the corresponding mask. The output from operation 1004 is a mask from the infrared image. An example mask 854 is shown in FIG. 21. The mask has a width and a height.

In some embodiments, the original values from the infrared image file are compared with parameters captured during a calibration process, and then adjusted based on the calibration parameters. For example, if the background is not perfectly flat or is not completely uniform, a shadow or smudge on the surface may cause certain pixels to be darker than other pixels, even though they are all background pixels illuminated with infrared light. Similarly, if the infrared light source shines more brightly in a center of the image than at the edges, the brightness detected at the edges may be darker than the brightness at the center. Therefore, the infrared image file pixels can be adjusted to account for these variations, such as by weighting the values and adjusting the values to uniform values. For example, a slightly darker edge pixel might be adjusted from a value of 245 to the maximum value of 255.

Next, a tile structure is defined for the mask (operation 1006). The mask is divided into tiles and each tile has a set width and height of a predetermined number of pixels. The width and height can be such that the tiles are square or rectangular.

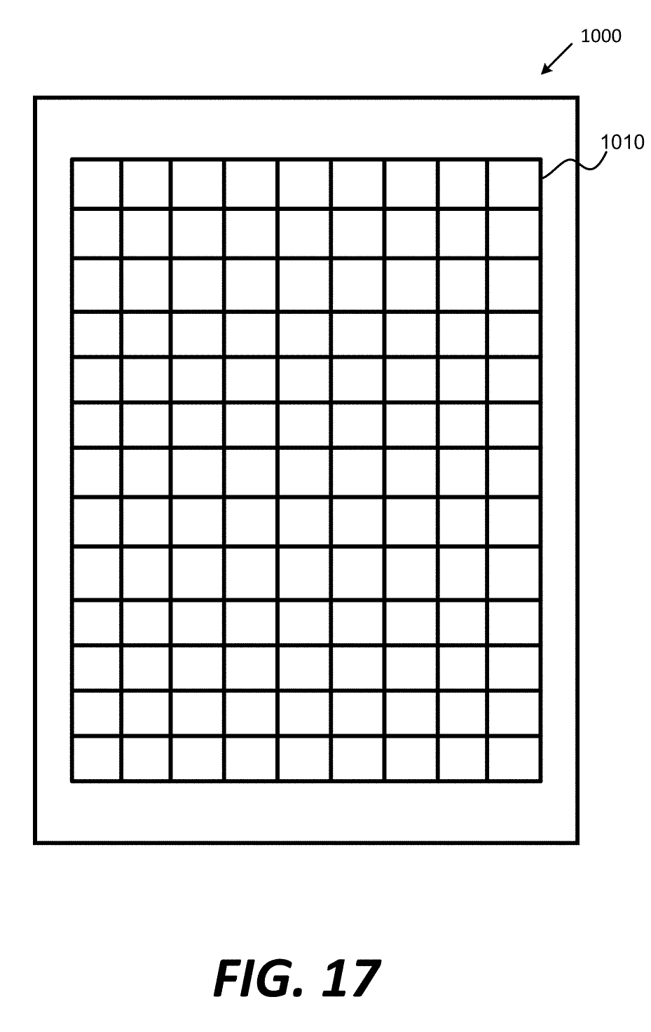

An example mask 1000 that has been divided into tiles 1010 is shown in FIG. 17. The number of horizontal tiles is determined by dividing the mask width by the width of the tiles. Similarly, the number of vertical tiles is determined by the mask height divided by the height of the tiles. As depicted, the tiles 1010 do not extend to the edges of the mask. In other embodiments, the entirety of the mask 1000 is divided into tiles 1010. In other embodiments, the tiles extend to the horizontal edges of the mask. Alternatively, in other embodiments, the tiles extend to the vertical edges of the mask. Other masks can have more or fewer tiles 1010.

In the example mask 1000, each tile 1010 has a width and height of 10 pixels. Each pixel in each tile 1010 in mask 1000 includes two data: the brightness value between 0 and 255 and a location identifier, such as (x, y) coordinates. These values are not shown in the embodiment of example mask 1000 shown in FIG. 17. Each tile has a center pixel, which is determined by finding the centroid of the tile or the intersection of two diagonals of the tile.

After defining the tile structure (operation 1006), the transition tiles are identified (operation 1008). Operation 1008 includes defining a computer structure containing additional information about each tile. This computer structure, which can be more than one computer structure in other embodiments, includes one or more of the following values: maximum value, minimum value, and transition. The transition tiles are the tiles in the mask that contain transitions between the background and the subject.

The maximum value is the largest pixel value in the tile, where the value is between 0 and 255 in the embodiment of the example mask 1000. The minimum value is the smallest pixel value in the tile. As noted above, each pixel additionally includes location data. Thus, the maximum value and the minimum values each correspond to a specific location in the tile or in the mask 1000.

In embodiments, the transition tiles in the mask 1000 are determined by subtracting the minimum value from the maximum value for each tile in the mask 1000. This difference is then compared to a threshold and if it is greater than or equal to the threshold, it is determined to be a transition tile.

The transition tiles can also be determined by comparing the maximum value of each tile to a maximum transition value and by comparing the minimum value of each tile to a minimum transition value. If the maximum value is greater than or equal to the maximum transition value and if the minimum value is less than or equal to the minimum transition value, then the tile is determined to be a transition tile.

The transition tiles can also be determined using values between 0 and 1. In one example, any pixels that are not determined to be part of the subject region or the background region, as discussed below, are identified as being part of the boundary region. Pixels in the transition (also called the boundary region) can be given a value between the first and second values, such as between 0 and 1, wherein the value represents a percentage of the subject represented by the pixel. For example, a pixel from the boundary region having a value of 128 can be assigned a value of 0.5 indicating that the pixel is composed of about 50% subject and 50% background. The mask values of 0, 1, and values between 0 and 1 are sometimes referred to herein as alpha (α) values.

In some embodiments, the pixel values of the infrared image are then processed to identify pixels that are determined to be part of the background region (operation 1009). This can be accomplished, for example, by comparing the values in the image with a threshold value (e.g., 230, 240, 245, 250, etc.) and determining that any pixel having a value greater than the threshold value is part of the background region. The process may also include analysis of adjacent regions of the image, such as to determine if adjacent pixels are associated with the background, and/or edge finding techniques, to utilize information contained in the surrounding or nearby pixels to predict whether a pixel of interest is truly a part of the background region. Pixels identified as part of the background region can be given a first value in the mask file, such as a value of 0.

The pixel values of the infrared image are also processed to identify pixels that are determined to be part of the subject region (operation 1009). This can be accomplished, for example, by comparing the values in the image with a threshold value (e.g., 19, 14, 9, 4, etc.) and determining that any pixel having a value greater than the threshold value is part of the subject region. The analysis may also include analysis of adjacent regions as discussed above to utilize information contained in the surrounding or nearby pixels to predict whether a pixel of interest is truly part of the subject region. Pixels identified as part of the subject region can be given a second value in the mask, such as a value of 1.

The mask values can then be used to process the visible color image to remove the background region (operation 1212) so that the subject is separated from the background.

In still other embodiments, an additional image is captured where the background lights and the subject lights are not illuminated. A purpose for capturing an image without any of the lighting elements illuminated is to measure and subtract ambient lighting from the images. This may be necessary as the f-stop value is lower and/or when capturing images in environments where the ambient lighting conditions cannot be fully or partially controlled.

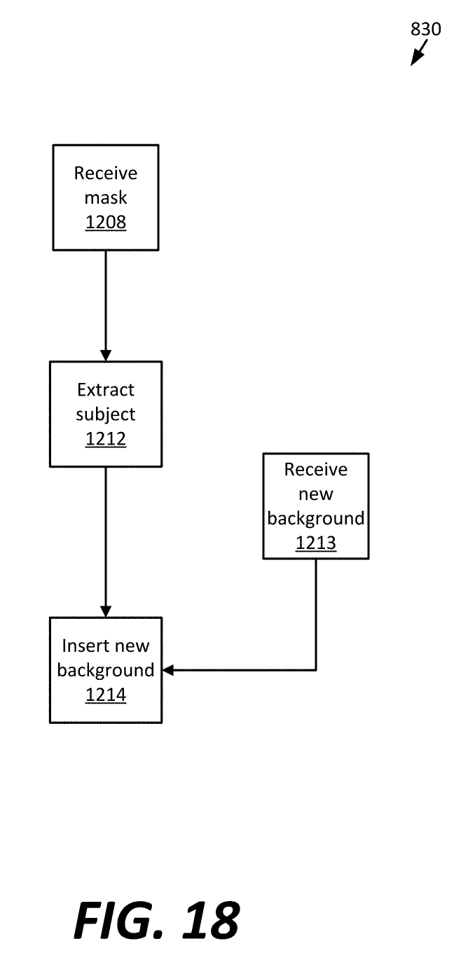

FIG. 18 is an embodiment of an example method 830 of generating a composite image. The example method 830 includes receiving a mask (operation 1208), extracting the subject (operation 1212), and inserting a new background (operation 1214). Other embodiments can include more or fewer steps.

The example method 1200 begins by receiving the mask (operation 1208) generated by the example method 822 discussed above. The user conducting or directing the operations in example method 1200 can be different from the user who initiated the example method 822.

After the composite mask is received (operation 1208), the subject is extracted (operation 1212). The mask should have a 1-to-1 correspondence in position with the subject in the visible light image. The mask has the same width and height dimensions in pixels as the visible light image. Thus, in one embodiment, one corner pixel of the mask can be aligned with the corresponding corner pixel of the visible light image.

Extracting the subject includes removing the background of the visible light image. The background is any portion of the subject-illuminated image that is not covered by the composite mask.

To remove the background (operation 1212), in some embodiments an object image function is computed. The object image function in this example is αF^{c} and is computed by the formula for each color channel:

αF^{c}=M−(1−α)B^{fl} (1)

where F^{c} is the corrected subject (foreground) pixel color vector in the visible light image (i.e., without any background mixed in), M is the original measured foreground image pixel color vector in the visible light image, and B^{fl} is the estimated background pixel color vector in the visible light image.

The background pixel values B^{fl} can be obtained from calibration parameters, such as from a visible light image captured during the calibration process with any subject present in the image. For cases where the background is sufficiently uniform, the background pixel value B^{fl} is a constant for all pixels; for a non-uniform background, the calibration parameters or other techniques can be used to model the background. The pixel color vectors discussed herein are also sometimes referred to as pixel values. The pixel color vector can include multiple pixel values, such as a value for each of the red, green, and blue color channels for an RGB image type (or other colors for other image types). Note that this formula is a rearrangement of the following formula:

R=αF+(1−a)B (2)

where R, F, and B are color vectors with red, green and blue components, α is the mask value identifying pixels as subject pixels, background pixels, or a ratio of subject to background, F is the foreground pixel, B is the background pixel, and R is the pixel resulting from alpha blending of the foreground and background pixels.

Because a is known and αF^{c} is known, F^{c} can be computed. Alternatively, as shown below, because αF^{c}, instead of F^{c} itself, is used for subsequent compositing with new background images, a and either F^{c} or αF^{c} can be stored or transmitted to the desired destinations (e.g., over computer networks such as the Internet) for later use in compositing with new background images.

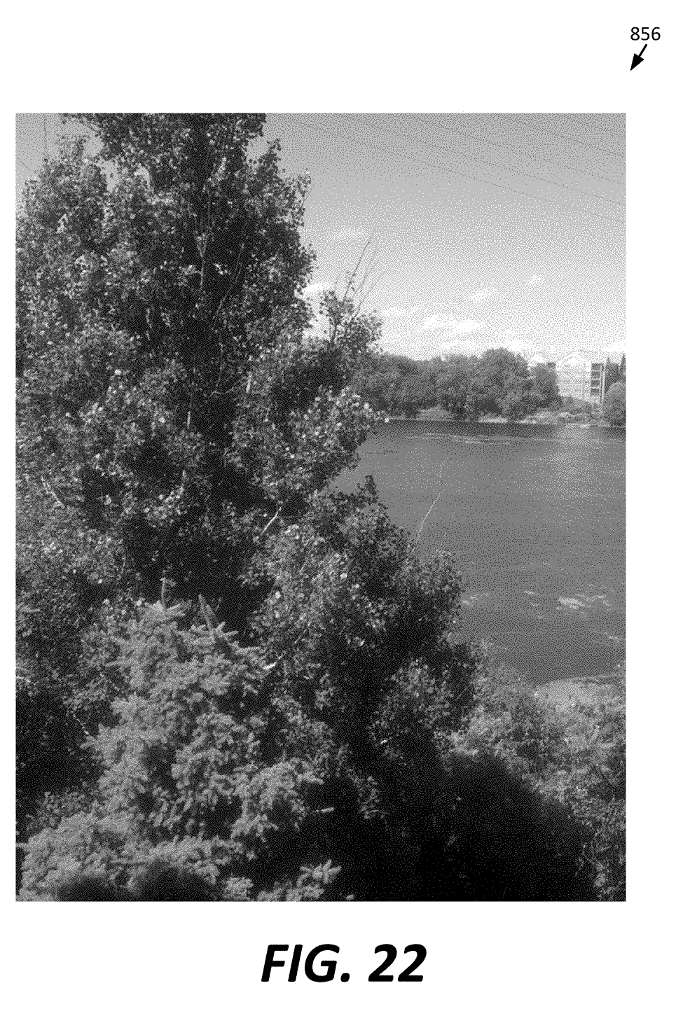

At some point during operation 832, a new background is received (operation 1213). An example background 856 is shown in FIG. 22.

At some point after extracting the subject (operation 1212) and a new background is received (operation 1213), a new background is inserted (operation 1214). The object image function, αF^{c}, and a new background image are combined to generate an image with the foreground image F^{c} in the new background (operation 1214). To generate the new image, the following formula can be used:

R=αF^{c}+(1−α)B^{new} (3)

where R is the resulting pixel color vector, and B^{new} is the new background pixel color vector.

In the new image, α is approximately 1 in the areas in registration with the image of the foreground object, and those areas are therefore occupied by the image of the foreground object. In contrast, α is approximately 0 in the areas outside image of the foreground object. Therefore, those areas are occupied by the new background image. In the border regions between the foreground and background images, α is between 0 and 1. The intensity level of each pixel in the border regions is thus a sum of the contributions from both the foreground image and background image. The foreground object therefore appears to be placed in front of the new background in the composite image, with properly blended edges between the two image regions, resulting in an exceptionally high quality image with very high resolution around the edges and highly accurate blending of the subject pixels with the pixels of the new background image. As a result, the foreground object appears naturally in front of the background.

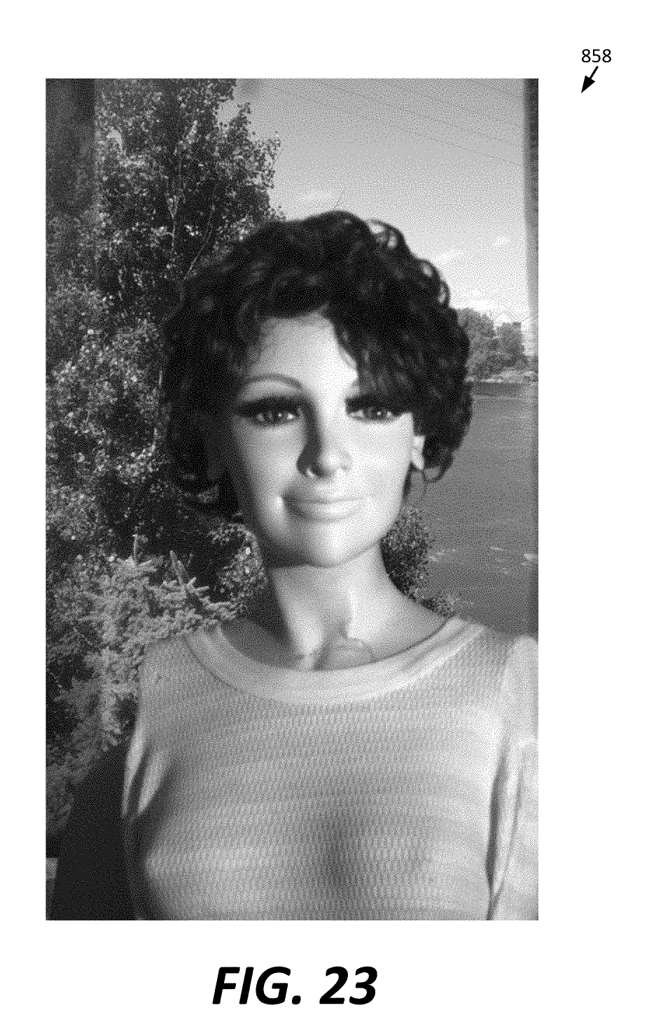

In school portrait embodiments, the background can be selected after a customer sees the subject-illuminated image without the background. For example, the customer could select multiple possible backgrounds and identify one that they prefer given the subject's clothing, hair color, eye color, etc. In products-as-subjects embodiments, a marketing department might decide upon a proper background for the subject-illuminate image. An example of the composite image 858 resulting from inserting the new background is shown in FIG. 23.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of imaging a subject with a digital camera, comprising:
illuminating a subject with a visible light assembly;
illuminating a background with an infrared light assembly; and
while illuminating the subject and illuminating the background, capturing an image with the digital camera, the digital camera having an image sensor array, the image sensor array including sensors configured to receive visible light and sensors configured to receive infrared light.

2. The method according to claim 1, further comprising:
using the image, generating a color image file; and
using the image, generating an infrared image file.

3. The method according to claim 1, further comprising:
filtering out infrared light from the visible light assembly.

4. The method according to claim 3, further comprising:
filtering out visible light from the infrared light.

5. The method according to claim 1, further comprising:
testing an environment for infrared light, the image being captured in the environment; and
determining an adjustment factor based on the testing, wherein generating the infrared image file includes using the adjustment factor.

6. The method according to claim 1, further comprising:
generating a mask based on the infrared image file.

7. The method according to claim 6, further comprising:
using the mask to remove a background portion of the color image file to generate a modified color image file.

8. The method according to claim 7, further comprising:
receiving a substitute background; and
generating a composite image using the modified color image file and the substitute background.

9. The method according to claim 8, further comprising:
illuminating a foreground object with a second infrared lighting unit.

10. The method according to claim 9, wherein using the mask to remove the background portion of the color image file further comprises:
removing the foreground object from the color image file.

11. The method according to claim 1, wherein the subject is an inanimate object.

12. A digital photography system, comprising:
a digital camera comprising a sensor array, the sensor array being configured to capture both visible light and infrared light;
a background lighting system including an infrared lighting unit;
a subject lighting system including a visible lighting unit; and
a controller in communication with the background lighting system and the subject lighting system, the controller comprising:
at least one processing device; and
at least one non-transitory data storage device, the data storage device storing instructions that, when executed by the at least one processing device, cause the controller to:
activate the background lighting system to emit infrared light;
activate the subject lighting system to emit visible light; and
when both the background lighting system and the subject lighting system are activated, activate the digital camera to capture an image with the sensor array.

13. The digital photography system of claim 12, further comprising: a mask generation system including a second non-transitory storage medium and one or more processors, the mask generation system configured to:
generate, using the image, a visible light image file and an infrared light image file.

14. The digital photography system of claim 13, wherein the mask generation system is further configured to:
using the infrared light image file, generate a mask file; and
using the mask file, remove a background portion of the visible light image file.

15. The digital photography system of claim 13, wherein the data storage device further stores instructions that, when executed by the at least one processing device, cause the controller to:
test an environment for infrared light, wherein the digital camera is located within the environment; and
determine an adjustment factor based on the test, wherein the infrared light image file is generated using the adjustment factor.

16. The digital photography system of claim 12, wherein the infrared lighting unit includes a visible light filter; and
wherein the visible lighting unit is configured to filter out infrared light.

17. The digital photography system of claim 12, wherein the sensor array includes a filter array including red filters, green filters, blue filters, and infrared filters.

18. A method for replacing a background of a digital image, the digital image including a subject, and the method comprising:
receiving an infrared image file, the infrared image being captured with an image sensor array, the image sensor array including a plurality of infrared sensors and a plurality of visible light sensors; and
using the infrared image, generating a mask.

19. The method according to claim 18, further comprising:
receiving a visible light image file, the visible light image being captured with the image sensor array, the visible light image resulting from reading out the signals received by the plurality of visible light sensors; and
using the mask, removing a background from the visible light image to generate a subject only image.

20. The method according to claim 19, further comprising:
adding a modified background to the subject only image; and
processing the visible light image to correct for at least one of: pixel multiplexing, channel crosstalk, and chromatic aberrations.
